(19) United States
(12) Patent Application Publication
(10) Pub. No.: US 2007/0250771 A1
(43) Pub. Date: Oct. 25, 2007

(54) Display with message prompt function and playing method thereof

(76) Inventors: Chi-Shih Lee, Taipei (TW); Chih-Li Huang, Taipei (TW); I-Wei Shen, Taipei (TW)

Correspondence Address: HARNESS, DICKEY & PIERCE, P.L.C., P.O. BOX 8910, RESTON, VA, 20195, US

(21) Appl. No.: 11/410,040

(22) Filed: Apr. 25, 2006

(51) Int. Cl. G09G 5/00; G05B 19/418

(52) U.S. Cl. 715/703; 700/14; 700/16; 705/8

(57) ABSTRACT

A display with a message prompt function and a playing method thereof are provided. A prompt message corresponding to a scheduled time is acquired and then played to remind a user, when the scheduled time set in a notepad is consistent with a real time after a comparison.

### BACKGROUND OF THE INVENTION

1. Field of Invention

The present invention relates to a display with a message prompt function and a playing method thereof, and more particularly, to a display with a message prompt function which plays a message prompt at a set time according to a prompt message set by a user and a playing method thereof.

2. Related Art

An audiovisual display apparatus provides the most direct sensory interface between people and information, related products such as televisions and computers. That is, the audiovisual display apparatus serves as an output apparatus presenting video and audio signals. At present, the television is the most popular audiovisual equipment in an ordinary family, especially in the information explosion era. With the development of science and technology, therefore people can enjoy scenery and places of interest all over the world, famous operas, exciting ball games, and so on, without going out, which is all attributed to highly developed technology. Just by using the play function of the television, through the transmission of real-time signals, a user can watch and listen to a program as if he/she feels it live. What's more, a user may be greatly satisfied in sense while enjoying a wonderful movie.

Referring to FIG. 1, it is a system block diagram of a multimedia player according to the prior art. The multimedia player comprises a data access module 11, an editor 13, a transmission interface 14, a play system 15, and a user interface 12. When a user conducts a play command through the user interface 12, multimedia data 10 is acquired through the data access module 11 and sent to the editor 13, and then transported to the play system 15 through the transmission interface 14 for playing.

While watching a multimedia program, the user should merely enjoy it from beginning to end, except in the case that the user could pause or stop playing it by him/herself. Generally, a whole program may last for a spell. Although the user has spare time to watch movies or programs, some cases, such as, replying to an important call, bringing children to and picking children up from school, or keeping an appointment, inevitably occur during watching. According to the prior art, the user should remind him/herself with assisting tools, such as, notebooks, Personal Digital Assistants (PDA), and notebook computers, or the user should remember an appointment in his/her mind, to remind him/herself at the time of the appointment. And it causes an inconvenience to the user to check the time constantly while watching movies or programs; otherwise, he/she might miss the appointment or miss wonderful episodes.

### SUMMARY OF THE INVENTION

In view of the above, the present invention provides a method of playing a message prompt, which is applicable to play a prompt message while playing the multimedia data, thereby solving the problem existing in the prior art.

Accordingly, in order to achieve the aforementioned object, the method for playing a prompt message disclosed in the present invention is applicable to a display capable of playing the multimedia data. The method comprises the steps as follows.

First, through an input interface, a user inputs a prompt message and sets a scheduled time in a notepad built in the display. Then, when displaying multimedia data, the scheduled time in the notepad is compared with a real time in a real-time pulse generator. If the real time, i.e., the current time, of the real-time pulse generator, is consistent with the scheduled time in the notepad, a corresponding prompt message is acquired. Subsequently, both the prompt message and the multimedia data are played on the display simultaneously.

According to the playing method of the present invention, while enjoying a multimedia program, the user is reminded of a plan, appointment message, and so on, according to the predetermined schedule and the prompt message in the notepad. Furthermore, the prompt message can be displayed on the screen of the display with the multimedia data in sync, independent of other assisting tools. Thereby, while watching programs or movies, the user need not check the time constantly and can fully enjoy the programs or movies.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and which thus is not limitative of the present invention, and wherein:

FIG. 1 is a system block diagram of a multimedia player according to the prior art;

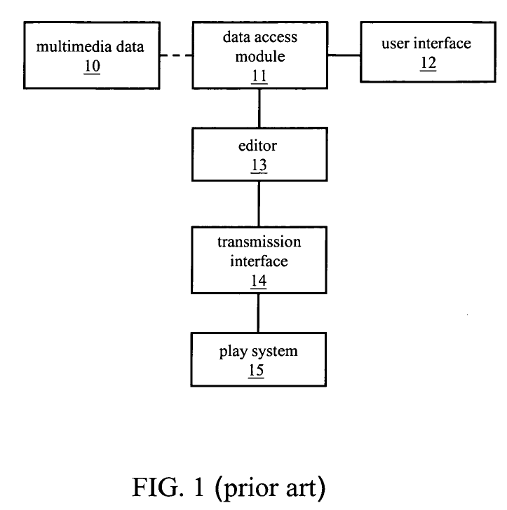

FIG. 2 is a flow chart of the playing method of the display with a message prompt function of the present invention; and

FIG. 3 is a system block diagram of the display of the present invention.

### DETAILED DESCRIPTION OF THE INVENTION

In order to make objects, structures, features, and functions of the present invention more apparent, preferred embodiments accompanied with drawings are described in detail below. It should be noted that the foregoing general description and the following detailed description are exemplary, and are intended to provide further explanation of the invention as claimed.

With the playing method disclosed in the present invention, a user can set a specific time by him/herself to play a preset prompt message, such that the user can be reminded without having to remember unfinished affairs and check the time constantly while playing multimedia data.

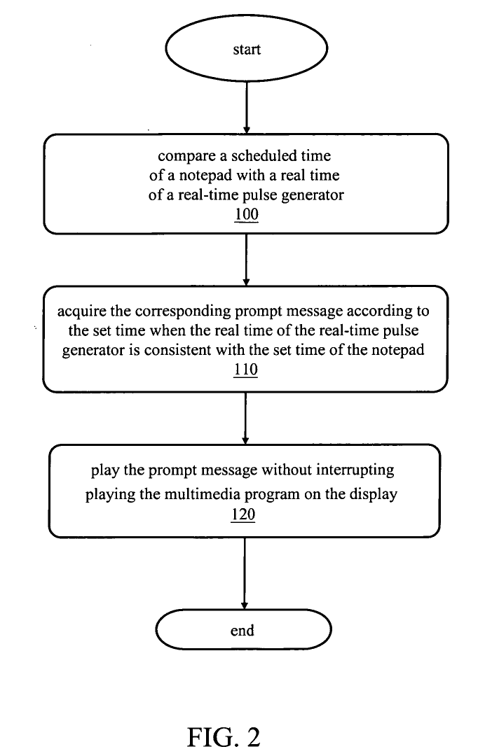

Referring to FIG. 2, it is a flow chart of the steps of the present invention. The method of playing a prompt message of a display disclosed in the present invention is applicable to a display capable of playing multimedia data. The display can be a cathode ray tube (CRT), a liquid crystal display, a plasma display panel (PDP), or the like. The playing method comprises the steps as follows.

Firstly, the display is powered on. The user inputs at least a prompt message 222, sets a display time, and stores them in a notepad 221 through various input interfaces 200 of the display, such as operation panel buttons on the display, a remote controller, a handwriting tablet, and a voice control unit. The notepad 221 and the prompt message 222 are restored in a memory 220. The memory 220 can be an EEPROM, a flash memory, a memory card, or the like. According to the present specifications, the memory card can be classified into one of an EEPROM, a flash memory, a compact flash (CF) card, a secure digital (SD) card, a smart media card (SMC), a multi-media card (MMC), a memory stick (MS) card, and so on.

Next, while the multimedia data is played on the display, the scheduled time in the notepad 221 is compared with a real time of a real-time pulse generator 231 (Step 100). That is, the play time of the prompt message 222 preset by the user is compared with the current time. Therefore, when the real time, i.e., the current time, of the real-time pulse generator 231 is consistent with the set time in the notepad 221, the corresponding prompt message 222 is acquired according to the set time (Step 110). Then, the prompt message 222 is tagged on the multimedia data, and then is played on the display with the multimedia program simultaneously, without interrupting playing the multimedia data on the display (Step 120). For example, the user can arrange schedules or affairs through the prompt function of the notepad 221, such that the user can enjoy programs or movies intently. Further, according to the message prompt function of the notepad 221, the prompt message is played in a sub-frame preset in the display by means of news ticker, so as to remind the user without interrupting the playing frame of the program. With the playing method, the user can enjoy a wonderful movie intently, without missing the affairs that should be done or forgetting important appointment schedule, such that the management of time is relatively easy.

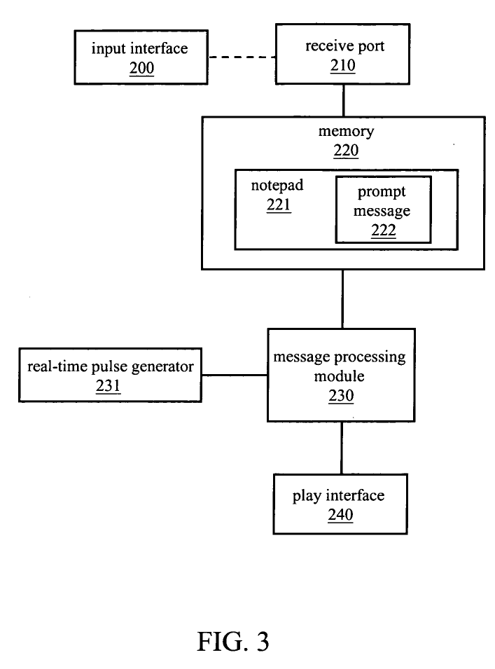

Referring to FIG. 3, it is a system block diagram of the display with a message prompt function disclosed in the present invention. The user inputs at least a prompt message 222 and sets a display time, and then stores them in the display with the notepad 221 function, such that the corresponding prompt message 222 is acquired at the scheduled time. Thereby, the prompt message 222 and the multimedia data are played on the screen of the display simultaneously. The display comprises a receive port 210, a memory 220, a message processing module 230, a real-time pulse generator 231, and a play interface 240.

The receive port 210 is used to receive the multimedia data and the prompt messages 222. The user inputs the prompt message 222 and sets the display time through at least one input interface 200 of the display, such as, operation panel buttons, a remote controller, a handwriting tablet, a voice control unit, an so on, wherein the prompt message 222 can be text data or voice data.

The prompt message 222 and the set display time are recorded in the notepad 221 and stored in the memory 220. Additionally, the memory 220 can be an EEPROM, a flash memory, or a memory card. According to the present specifications, the memory card can be classified into one of an EEPROM, a flash memory, a CF card, a SD card, a SMC, a MMC card, a MS card, and so on.

The real-time pulse generator 231 is used to make the display have a indicated time corresponding to or in sync with the current time.

The message processing module 230 is used to acquire the corresponding prompt message 222 according to the comparison result between the indicated time by the real-time pulse generator 231 and the scheduled time in the notepad 221.

The play interface 240 is used to play multimedia data and acquire the corresponding prompt message 222 at the scheduled time set in the notepad 221, and then play the prompt message 222 and the multimedia data simultaneously, i.e., display through the divided sub-frame on the display, without interrupting playing the multimedia data. The prompt message 222 is displayed by means of news ticker, wherein the content includes prompt texts or a prompt sound effect played by speakers.

In addition, a further embodiment is illustrated below. It should be noted that the means of the embodiment is the same as that of FIG. 3, and will not be further described herein. A channel is set to play the prompt message 222, wherein the channel does not play any multimedia data. As such, when reaching the scheduled time recorded in the notepad 221, the corresponding prompt message 222 is acquired and played through the set channel. Meanwhile, the multimedia channel enjoyed at present is switched to the set channel, wherein the displaying content includes prompt texts or prompt sound effects. The prompt message 222 is displayed by means of news ticker, thereby achieving the object of reminding the user.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of playing a prompt message for a display, applicable to a display capable of playing multimedia data, comprising:
comparing a scheduled time set in a notepad with a real time;
when the real time is consistent with the scheduled time, acquiring at least a prompt message; and
playing the prompt message and the multimedia data on the display simultaneously.

2. The playing method as claimed in claim 1, wherein the notepad and the prompt message are stored in a memory.

3. The playing method as claimed in claim 2, wherein the memory is selected from a group consisting of an EEPROM, a flash memory, and a memory card.

4. The playing method as claimed in claim 3, wherein the memory card is selected from a group consisting of an EEPROM, a flash memory, a compact flash (CF) card, a secure digital (SD) card, a smart media card (SMC), a multi-media card (MMC), and a memory stick (MS) card.

5. The playing method as claimed in claim 1, wherein the scheduled time of the notepad and the prompt message are set through an input interface.

6. The playing method as claimed in claim 5, wherein the input interface are panel buttons on the display.

7. The playing method as claimed in claim 5, wherein the input interface is a remote controller of the display.

8. The playing method as claimed in claim 1, wherein the prompt message comprises text data.

9. The playing method as claimed in claim 1, wherein the prompt message comprises voice data.

10. The playing method as claimed in claim 1, wherein the display is selected from a group consisting of a cathode ray tube (CRT), a liquid crystal display, and a plasma display panel (PDP).

11. A display with a message prompt function, comprising:
a receive port, for receiving multimedia data and at least a prompt message;
a memory, for storing a notepad used to store the prompt messages and a scheduled time;
a real-time pulse generator, for generating a real time;
a message processing module, for acquiring the prompt message according to the scheduled time and the real time; and
a play interface, for playing the prompt message and the multimedia data simultaneously.

12. The display as claimed in claim 11, wherein the memory is selected from a group consisting of an EEPROM, a flash memory, and a memory card.

13. The display as claimed in claim 12, wherein the memory card is selected from a group consisting of an EEPROM, a flash memory, a CF card, a SD card, a SMC, a MMC, and a MS card.

14. The display as claimed in claim 11, wherein the scheduled time and the prompt message are set through an input interface.

15. The display as claimed in claim 14, wherein the input interface are panel buttons of the display.

16. The display as claimed in claim 14, wherein the input interface is a remote controller of the display.

17. The display as claimed in claim 11, wherein the prompt message comprises text data.

18. The display as claimed in claim 11, wherein the prompt message comprises voice data.
